(19) United States
(12) Patent Application Publication
(10) Pub. No.: US 2026/0094280 A1
(43) Pub. Date: Apr. 2, 2026

(54) CYCLIC GUIDANCE FOR MASK-BASED VIDEO MATTING

(71) Applicant: Adobe Inc., San Jose, CA (US)

(72) Inventors: Kenji ENOMOTO, Sunnyvale, CA (US); Guolei SUN, Jose, CA (US); Tenell RHODES, San Jose, CA (US); Brian PRICE, Pleasant Grove, UT (US)

(73) Assignee: Adobe Inc., San Jose, CA (US)

(21) Appl. No.: 18/900,062

(22) Filed: Sep. 27, 2024

(51) Int. Cl. G06T 7/194; G06T 7/11

(52) U.S. Cl. CPC G06T 7/194; G06T 7/11; G06T 2207/10016; G06T 2207/20084; G06T 2207/20212

(57) ABSTRACT

Embodiments are disclosed for a digital design system trained to generate alpha matte frames of a video sequence using cyclical guidance of previous video frames. The method may include receiving a video sequence and an input masked video frame for a first video frame of the video sequence. The disclosed systems and methods further comprise generating alpha matte frames for the video sequence using the video sequence and the input masked video frame, wherein a first network generates masked video frames based on stored features of previous frames of the video sequence and a second network generates the alpha matte frames based on the masked video frames and the stored features of the previous frames of the video sequence. Using the generated alpha matte frames, an alpha matte video sequence representation of the video sequence can be output.

### BACKGROUND

Effective video editing can be vital for storytelling, marketing, and content creation. One aspect of video editing is the creation of alpha mattes for an object of interest, which is useful for video editing tasks such as background replacement and color adjustment. As the object of interest may be continuously moving through each video frame of the video sequence, creating alpha mattes for an entire video sequence can be a challenging task.

### SUMMARY

Introduced here are techniques/technologies that allow a digital design system to generate an alpha matte video sequence representation of an input video sequence given a single masked video frame as an input.

More specifically, in one or more embodiments, a digital design system processes a sequence of video frames of a video sequence through a pipeline of machine learning models. The input to the digital design system is a video sequence and an input masked video frame for the first video frame of the video sequence. The input masked video frame can be a binary mask for the first frame that indicates whether each pixel is a foreground or background pixel. Each video frame of the video sequence is then first processed through a first encoder-decoder network of a video segmentation module trained to generate a masked video frame representation of the video frame. The masked video frame representation of the video frame is then passed through a second encoder-decoder network of a video matting module trained to generate an alpha matte frame representation of the video frame. The features of the alpha matte frames generated by the second encoder-decoder for each frame is stored in one or more memories. The features used to generate the marked video frame and alpha matte frame by the first and second encoder-decoder networks, respectively, are then supplemented with the stored features of the alpha matte frames of previous video frames of the same video sequence that were previously processed through the pipeline. After processing the video frames of the video sequence, the video frames can be combined to generate an alpha matte video sequence representation of the video sequence.

In one or more embodiments, additional features can be provided to further improve the alpha matting process performed by the video matting module. In such embodiments, multi-layer features generated by one or more layers of the encoder of the video segmentation module can be provided as an additional input to the decoder of the video matting module.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of generating an alpha matte video sequence representation of a video sequence using machine learning models in accordance with one or more embodiments;

FIG. 2 illustrates a diagram of a process of generating a masked video frame representation of a video frame using a video segmentation module in accordance with one or more embodiments;

FIG. 3 illustrates a diagram of a process of generating an alpha matte representation of a video frame using a video matting module in accordance with one or more embodiments;

FIG. 4 illustrates a comparison of qualitative results generated by a digital design system in accordance with one or more embodiments;

FIG. 5 illustrates a diagram of a process of training machine learning models to generate masked video frames and alpha matte frames of a video sequence in accordance with one or more embodiments;

FIG. 6 illustrates a schematic diagram of a digital design system in accordance with one or more embodiments;

FIG. 7 illustrates a flowchart of a series of acts in a method of generating an alpha matte video sequence representation of a video sequence using machine learning models of a digital design system in accordance with one or more embodiments; and

FIG. 8 illustrates a block diagram of an exemplary computing device in accordance with one or more embodiments.

### DETAILED DESCRIPTION

One or more embodiments of the present disclosure include a digital design system with neural networks trained to generate an alpha matte video sequence representation of an input video sequence given a single masked video frame. Some prior techniques require trimap priors, where a user is required to manually annotate foreground, background, and unknown regions (e.g., pixels that are a mixture of foreground and background). Other techniques can use an image segmentation method to either assign a pixel to be either foreground or background, and then manually select pixels that are in the unknown region. However, both of these prior techniques can be difficult, time consuming and resource intensive as they require a user to repeat the process of manual annotations for each frame of a video sequence. These and other existing techniques that attempt to propagate a single trimap prior produce unsatisfactory results that have issues with temporal coherence (e.g., flickering in the resulting outputs) and stability. Further, as the length of a video sequence increases, the issues with temporal coherence and stability only exacerbate.

To address these and other deficiencies in conventional systems, the digital design system of the present disclosure includes neural networks trained to generate masked video frames and alpha matte frames representing video frames of a video sequence, while using a cyclical memory that is updated with the features of previous video frames after each previous video frame is processed through the pipeline. In embodiments, the cyclically-guided matting process feeds the features of at least the previous alpha mattes generated for video frames of a video sequence back to the video segmentation module to produce a masked video frame for a current video frame that more accurately captures the object of interest (e.g., established in the initial input masked video frame). Similarly, the cyclically-guided matting process feeds the features of at least the previous alpha mattes generated for video frames of a video sequence back to the video matting module to produce alpha mattes with greater temporal coherence.

The digital design system of the present disclosure presents improved alpha matting of an input video sequence that addresses the limitations of the existing solutions. One advantage of the digital design system of the present disclosure is the generation of a more consistent alpha matting of the plurality of video frames of a video sequence that requires only a single masked video frame for a first frame of the video sequence as an input. The digital design system of the present disclosure also produces an enhanced user experience as the user only needs to generate an initial input masked video frame, conserving time and computing resources. Further, the use of the cyclically-guided process to feed features of previous video frames when generating a current video frames results in improved matting results even when the input video sequence is long (e.g., includes a large number of video frames).

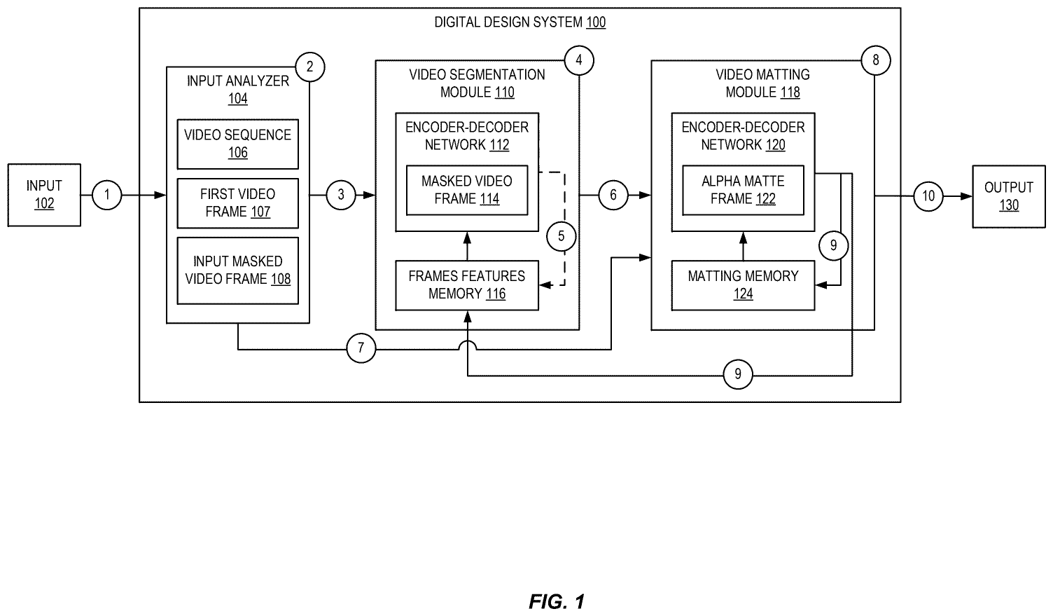

FIG. 1 illustrates a diagram of a process of generating an alpha matte video sequence representation of a video sequence using machine learning models in accordance with one or more embodiments. As shown in FIG. 1, a digital design system 100 receives an input 102, as shown at numeral 1. For example, the digital design system 100 receives the input 102 from a user via a computing device or from a memory or storage location. In one or more embodiments, the input 102 includes at least a video sequence 106, a first video frame 107 of the video sequence 106, and an input masked video frame 108 version of the first video frame 107. For example, the input 102 can be a document or file that includes the video sequence. In one or more embodiments, the input 102 can be provided in a graphical user interface (GUI). For example, a user can indicate a storage location (e.g., on a computing device) or a URL to a location storing the video sequence 106, the first video frame 107, and/or the input masked video frame 108.

The digital design system 100 includes an input analyzer 104 that receives the input 102. In some embodiments, the input analyzer 104 is configured to extract the video sequence 106, the first video frame 107, and the input masked video frame 108, at numeral 2. In one or more embodiments, the first video frame 107 can be a sequentially first video frame of the video sequence 106 or a frame in the middle of the video sequence 106. In one or more embodiments, the input masked video frame 108 is a binary-masked representation of the first video frame 107, where each pixel of the input masked video frame 108 represents whether the corresponding pixel of the first video frame 107 is a foreground pixel or a background pixel. The masking in the input masked video frame 108 specifies an object of interest in the video sequence 106. In one or more embodiments, the input includes the video sequence 106 and the input masked video frame 108, and the first video frame 107 is extracted from the video sequence 106 based on information indicating the video frame of the video sequence 106 that is associated with the input masked video frame 108. In one or more embodiments, the input analyzer 104 can segment the video sequence 106 into a plurality of video frames.

In one or more embodiments, the first video frame 107 and the input masked video frame 108 are sent to a video segmentation module 110, as shown at numeral 3. In one or more embodiments, video segmentation module 110 include an encoder-decoder network 112, or a similar neural network, and a frames features memory 116. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the frames features memory 116 is configured to store alpha matte frames from previous video frames processed by the video segmentation module 110 and the video matting module 118. In other embodiments, the frames features memory 116 is also configured to store masked video frames from previous video frames processed by the video segmentation module 110.

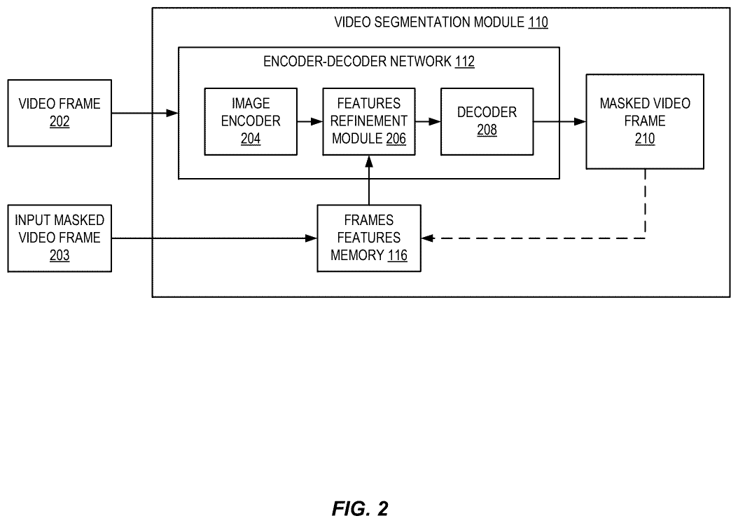

In one or more embodiments, the video segmentation module 110 is configured to generate a masked video frame 114 by passing the first video frame 107 and the input masked video frame 108 through the encoder-decoder network 112, at numeral 4. The masked video frame 114 is a binary-masked representation of the first video frame 107. Additional details of the process of generating the masked video frame 114 are described with respect to FIG. 2.

In one or more embodiments, the masked video frame 114, or features of the masked video frame 114, can optionally be stored in the frames features memory 116, as shown at numeral 5. In one or more embodiments, the masked video frame 114, or features of the masked video frame 114, can be stored in the frames features memory 116 to assist in generating masked video frames for subsequent video frames of the video sequence 106. Alternatively, processing may proceed as shown at numeral 6, without storing the masked video frame 114, or features of the masked video frame 114, in the frames features memory 116.

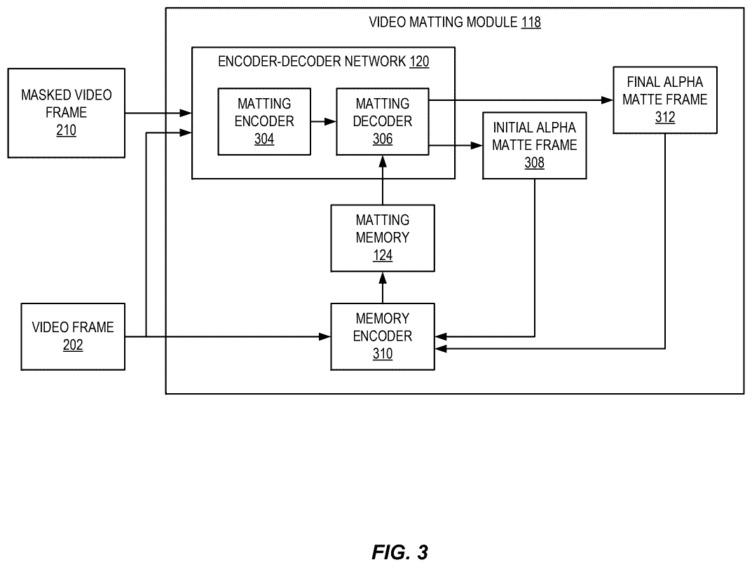

After the video segmentation module 110 generates the masked video frame 114, the masked video frame 114 can be sent to the video matting module 118, as shown at numeral 6. The first video frame 107 can also be sent to the video matting module 118, as shown at numeral 7. The video matting module 118 is configured to generate an alpha matte frame 122 by passing the first video frame 107 and the masked video frame 114 through an encoder-decoder network 120, at numeral 8. Additional details of the process of generating the alpha matte frame 122 are described with respect to FIG. 3.

In one or more embodiments, the alpha matte frame 122, or features of the alpha matte frame 122, are sent to both the frames features memory 116 and the matting memory 124 for storage, as shown at numeral 9. In one or more embodiments, the alpha matte frame 122, or features of the alpha matte frame 122, can be stored in the frames features memory 116 and the matting memory 124 to assist in generating alpha matte frames for subsequent video frames of the video sequence 106.

The steps in numerals 3-9 can then be iteratively repeated for each consecutive frame of the video sequence 106 to generate corresponding alpha matte frames. The features stored in the frames features memory 116 and the matting memory 124 are updated after each pass through the digital design system 100 and provides cyclical guidance to the processing of subsequent video frames of the same video sequence. In one or more embodiments, the steps in numerals 3-9 are iteratively repeated until all video frames, or a designated subset of the video frames, of the video sequence 106 have been processed. For each video frame of the video sequence 106 after the first video frame 107, the input to the video segmentation module 110 includes only the video frame.

After processing the video frames of the video sequence 106 to generate the corresponding alpha matte frames, the alpha matte frames generated by the digital design system 100 can be combined to generate an alpha matte video sequence representation of the video sequence 106. In one or more embodiments, the alpha matte video sequence representation of the video sequence 106 can be sent as an output 130, as shown at numeral 10. In one or more embodiments, after the process described above in numerals 1-9, the output 130 is sent through a communications channel to the user device or computing device that provided the input requesting the alpha matte video sequence representation of the video sequence 106, to another computing device associated with the user or another user, or to another system or application.

In one or more embodiments, as the image encoder of the encoder-decoder network 112 of the video segmentation module 110 compresses the first video frame 107 through multiple layers to extract the features of the first video frame 107, finer details that are visible at a large scale/resolution may be subsequently compressed at a small scale/resolution such that they are no longer visible. In some embodiments, to preserve these details, these multi-scale features generated by the image encoder of the encoder-decoder network 112 at the various layers are extracted and concatenated with the masked video frame 114. These multi-scale features can then be fed into the matting decoder of the encoder-decoder network 120 of the video matting module 118 as additional features used to generate the alpha matte frame 122. In such embodiments, details that may have been lost in generating the masked video frame 114 can be recovered by providing the multi-scales features to inform the matting process performed by the video matting module 118.

FIG. 2 illustrates a diagram of a process of generating a masked video frame representation of a video frame using a video segmentation module in accordance with one or more embodiments. A video segmentation module 110 can include an encoder-decoder network 112 and a frames features memory 116. In one or more embodiments, the encoder-decoder network 112 includes an image encoder 204, a features refinement module 206, and a decoder 208. As illustrated in FIG. 2, a video frame 202 is received by the video segmentation module 110. In one or more embodiments, the video frame 202 can be received from a storage location. In one or more embodiments, the video frame 202 is passed to encoder-decoder network 112. The video frame 202 can be one of a plurality of video frames that make up a video sequence. The plurality of video frames can be passed through the encoder-decoder network 112 sequentially.

When the video frame 202 is a first video frame of the video sequence, the input to the video segmentation module 110 also includes an input masked video frame 203 corresponding to the first video frame. In such embodiments, the input masked video frame 203 is a masked video frame that indicates whether the corresponding pixels of the first video frame are foreground pixels or background pixels. The input masked video frame 203 can be sent to the frames features memory 116 as an initial memory data for guiding the masked video frame generation process performed by the video segmentation module 110.

In one or more embodiments, after providing the video frame 202 to the image encoder 204, the image encoder 204 generates features representing the video frame 202 (e.g., a features vector representation). The generated features are then passed to a features refinement module 206. In one or more embodiments, the features refinement module 206 retrieves or receives features data for one or more previous video frames from the same video sequence as video frame 202 from the frames features memory 116. As noted above, when the video frame 202 is the first video frame of the video sequence, the frames features memory 116 may only include the input masked video frame 203 correlated to the first video frame of the video sequence. For subsequent video frames 202 after the first video frame, the frames features memory 116 will be populated with the data of alpha matted video frames generated from masked video frames that were previously generated by the video segmentation module 110 and passed through a video matting module (e.g., video matting module 118). For example, where video frame 202 is the fifth video frame of a video sequence, the frames features memory 116 can include the features data for the alpha matte frames preceding the fifth video frame that were generated by the video matting module 118.

In one or more embodiments, the features data in the frames features memory 116 can also include features data of masked video frames generated from video frames previously processed by the video segmentation module 110.

In one or more embodiments, the features refinement module 206 combines, concatenates, or otherwise applies the stored features from the frames features memory 116 to the features representing the video frame 202. In such embodiments, the output of the features refinement module 206 is an enhanced features (e.g., an enhanced feature vector) representation of the video frame 202. The enhanced features are then passed to the decoder 208. In one or more embodiments, the decoder 208 generates masked video frame 210. The masked video frame 210 can be a binary-masked representation of the video frame 202, where a value assigned to each pixel indicates whether the corresponding pixel of the video frame 202 is a foreground pixel or a background pixel.

FIG. 3 illustrates a diagram of a process of generating an alpha matte frame representation of a video frame using a video matting module in accordance with one or more embodiments. A video matting module 118 can include an encoder-decoder network 120, a memory encoder 310, and a matting memory 124. In one or more embodiments, the encoder-decoder network 120 includes a matting encoder 304 and a matting decoder 306. As illustrated in FIG. 3, a video frame 202 and a masked video frame 210 representation of the video frame 202 generated by a video segmentation module 110 (as described with respect to FIG. 2) is received by the video matting module 118. In one or more embodiments, the masked video frame 210 can be received from a storage location or directly from the video segmentation module 110 as the masked video frame 210 is generated. In one or more embodiments, the video frame 202 and the masked video frame 210 are passed to encoder-decoder network 120. The masked video frame 210 can be one of a plurality of masked video frames, where the plurality of video frames can be passed through the encoder-decoder network 120 sequentially.

In one or more embodiments, the matting encoder 304 generates features representing the video frame 202 and the masked video frame 210 (e.g., a features vector representation). The features representing the video frame 202 and the masked video frame 210 are then passed to the matting decoder 306. In one or more embodiments, the matting decoder 306 generates an initial alpha matte frame 308. The initial alpha matte frame 308 can then be provided to the memory encoder 310. In addition, the video frame 202 is also provided to the memory encoder 310.

In one or more embodiments, when the video frame 202 is a video frame subsequent to a first video frame, to produce a final alpha matte frame 312 for the video frame 202, the video frame 202 and the masked video frame 210 are passed through the encoder-decoder network 120 an additional time. In the second passthrough, the matting memory 124 provides multi-layer features to the matting decoder 306 to improve the output of the video matting module 118. The provision of the multi-layer features can also reduce model redundancy (e.g., avoiding the features encoded by the video segmentation module 110 from being re-encoded by the video matting module 118) and allow the video matting module 118 to focus on encoding matting-specific features. In such embodiments, the memory encoder 310 generates features data (e.g., feature vectors) representing the video frame 202, the initial alpha matte frame 308 generated for the masked video frame 210, and the initial alpha matte frames 308 and final alpha matte frames 312 generated for previous video frames of the video sequence. The features data generated by the memory encoder 310 are then provided to the matting memory 124. For example, as the matting decoder 306 passes the compressed features generated by the matting encoder 304 through layers of the matting decoder 306, the compressed features are upsampled. At one or more of the layers of the matting decoder 306, the matting memory 124 feeds the stored multi-layer features of a corresponding layer/level to the matting decoder 306 to improve the quality and resolution of the final alpha matte frame 312. In one or more embodiments, the multi-layer features from the matting memory 124 can be added, or concatenated, to the features being upsampled by the matting decoder 306 to eliminate unnecessary features in background regions of the video frame and supplement necessary features in foreground regions of the video frame.

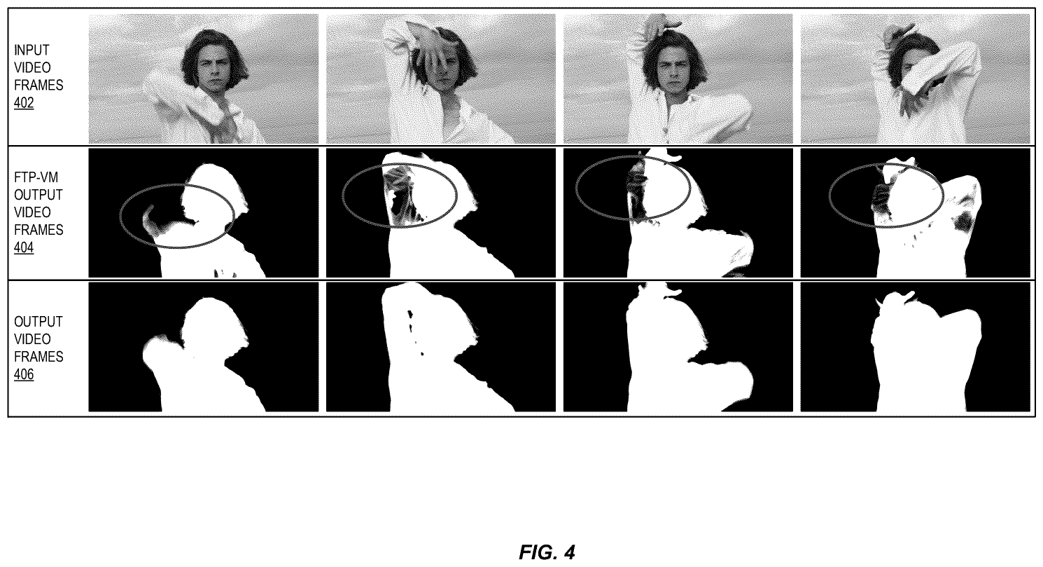

FIG. 4 illustrates a comparison of qualitative results generated by a digital design system in accordance with one or more embodiments. In FIG. 4, video frames 402 are video frames from a video sequence. Fast Trimap Propagation-Video Matting (FTP-VM) uses a single trimap prior for a video frame as an input that is propagated to other frames to produce alpha mattes. As shown in FIG. 4, the resulting FTP-VM output video frames 404 exhibit significant artifacts as the object of interest moves from frame to frame, resulting in a loss of coherence of the alpha matte generated by FTP-VM. Further, for later video frames of the input video frames 402, the resulting FTP-VM output video frames 404 exhibit increased loss of coherence of the object of interest. In contrast, the output video frames 406 generated by the digital design system using cyclical-guidance of previous alpha matte frames, as described herein, produces alpha mattes with minimal to no artifacts or loss of coherence of the object of interest.

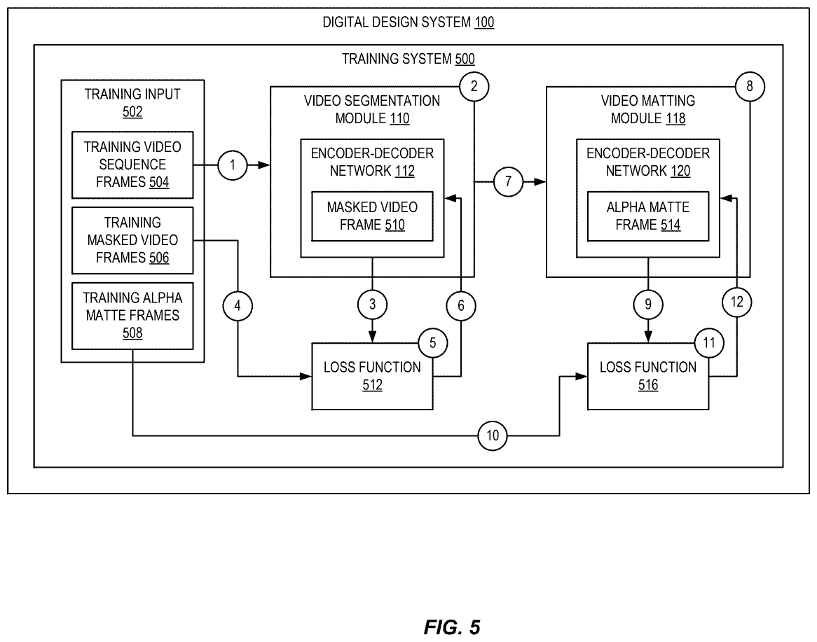

FIG. 5 illustrates a diagram of a process of training machine learning models to generate masked video frames and alpha matte frames of a video sequence in accordance with one or more embodiments. In one or more embodiments, a training system 500 is configured to train neural networks (e.g., encoder-decoder network 112 and encoder-decoder network 120) to generate masked video frames and alpha matte frames of a video sequence. In some embodiments, the training system 500 is a part of a digital design system 100. In other embodiments, the training system 500 can be a standalone system, or part of another system, and deployed to the digital design system 100. For example, the training system 500 may be implemented as a separate system implemented on electronic devices separate from the electronic devices implementing digital design system 100. As shown in FIG. 5, the training system 500 receives a training input 502. For example, the digital design system 100 receives the training input 502 from a user via a computing device or from a memory or storage location. The training input 502 can include training video sequence frames 504 and corresponding training masked video frames 506 and training alpha matte frames 508.

The training video sequence frames 504 are sent to a video segmentation module 110, as shown at numeral 1. In one or more embodiments, the training video sequence frames 504 are sent to the video segmentation module 110 serially or in parallel. The video segmentation module 110 generates a masked video frame 510 for each of the training video sequence frames 504, at numeral 2, as described previously with respect to FIG. 2. The masked video frame 510 for each of the training video sequence frames 504 are then sent to a loss function 512, as shown at numeral 3. The training masked video frames 506 are also passed to the loss function 512, as shown at numeral 4. Using the training masked video frames 506 and the masked video frame 510 for each of the training video sequence frames 504, the loss function 512 can calculate a loss, at numeral 5. In one or more embodiments, a bootstrapped cross entropy loss and dice loss with equal weighting are used. The calculated loss can then be backpropagated to train the encoder-decoder network 112, as shown at numeral 6.

The masked video frame 510 for each of the training video sequence frames 504 generated by the video segmentation module 110 are also sent to the video matting module 118, as shown at numeral 7. The video matting module 118 generates an alpha matte frame 514 corresponding to each masked video frame 510, at numeral 8, as described previously with respect to FIG. 3. The alpha matte frame 514 for each masked video frame 510 is then sent to a loss function 516, as shown at numeral 9. The training alpha matte frames 508 are also passed to the loss function 516, as shown at numeral 10. Using the training alpha matte frames 508 and the alpha matte frame 514 for each of the masked video frame 510, the loss function 516 can calculate a loss, at numeral 11. In one or more embodiments, the loss function 516 can include a regression loss (e.g., an L1 or L2 loss between the training alpha matte frames 508 and the alpha matte frame 514 for each of the masked video frame 510), a composition loss (e.g., an L1 or L2 loss between composite images computed by the training alpha matte frames 508 and the alpha matte frame 514), and a Laplacian pyramid loss (e.g., computed between the training alpha matte frames 508 and the alpha matte frame 514). In one or more embodiments, the composite images computed using the training alpha matte frames 508 and the alpha matte frame 514 can be expressed as follows:

$$\begin{matrix}C = aF + ( 1 - a ) B \\ {C}^{′} = {a}^{′} F + ( 1 - {a}^{′} ) B\end{matrix}$$

where a and a′ are the training alpha matte frames 508 and the alpha matte frame 514, respectively, F is a foreground image, and B is a background image. The calculated loss can then be backpropagated to train the encoder-decoder network 120, as shown at numeral 12.

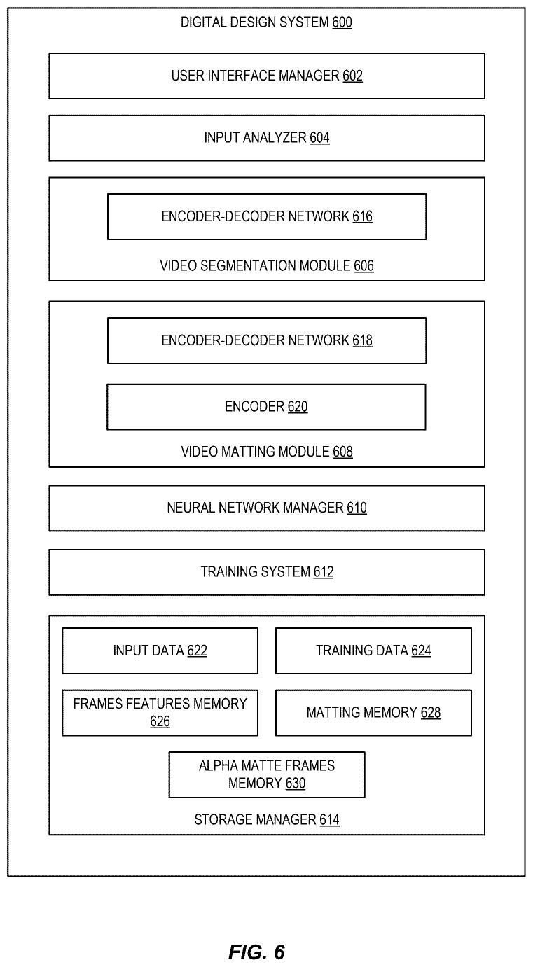

FIG. 6 illustrates a schematic diagram of a digital design system (e.g., “digital design system” described above) in accordance with one or more embodiments. As shown, the digital design system 600 may include, but is not limited to, a user interface manager 602, an input analyzer 604, a video segmentation module 606, a video matting module 608, a neural network manager 610, a training system 612, and a storage manager 614. The video segmentation module 606 includes an encoder-decoder network 616. The video matting module 608 includes an encoder-decoder network 618 and an encoder 620. The storage manager 614 includes input data 622, training data 624, a frames features memory 626, a matting memory 628, and alpha matte frames memory 630.

As illustrated in FIG. 6, the digital design system 600 includes a user interface manager 602. For example, the user interface manager 602 allows users to provide input data to the digital design system 600. In some embodiments, the user interface manager 602 provides a user interface through which the user can upload a video sequence and an input masked video frame corresponding to a first frame of the video sequence, as discussed above. Alternatively, or additionally, the user interface may enable the user to download the video sequence and the input masked video frame from a local or remote storage location (e.g., by providing an address (e.g., a URL or other endpoint) associated with a data source).

As further illustrated in FIG. 6, the digital design system 600 also includes an input analyzer 604. The input analyzer 604 analyzes an input received by the digital design system 600 to identify a video sequence. In one or more embodiments, the input analyzer 604 can also segment the video sequence into a plurality of video frames.

As further illustrated in FIG. 6, the digital design system 600 also includes a video segmentation module 606 configured to generate masked video frames for an input video frame of a video sequence. In one or more embodiments, the video segmentation module 606 includes an encoder-decoder network 616. The encoder-decoder network 616 can be trained to extract features, or feature vectors, from an input video frame of a video sequence, and generate a binary-masked video frame representation of an input video frame. The process of generating the binary-masked video frame representation of an input video frame can be further guided by a features of previous alpha matted video frames, and optionally masked video frames, generated for previous video frames of the same video sequence.

In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

As further illustrated in FIG. 6, the digital design system 600 also includes a video matting module 608 configured to generate alpha matte frames for an input masked video frame of a video sequence. In one or more embodiments, the video matting module 608 includes an encoder-decoder network 618 and an encoder 620. The encoder-decoder network 618 can be trained to extract features, or feature vectors, from a video frame and an input masked video frame representation of the video frame generated by the video segmentation module 606 and generate an alpha matte frame representation of the video frame. The process of generating the alpha matte frame representation of the video frame can be further guided by features of previous alpha matted video frames generated for previous video frames of the same video sequence. In such embodiments, the features of the previous alpha matted video frames are provided to a matting memory via the encoder 620. The encoder 620 can generates the features by processing the video frame and an initial alpha matte frame and provide the generated features to the matting memory 628.

As illustrated in FIG. 6, the digital design system 600 also includes a neural network manager 610. Neural network manager 610 may host a plurality of neural networks or other machine learning models, such as encoder-decoder network 616, encoder-decoder network 618, and encoder 620. The neural network manager 610 may include an execution environment, libraries, and/or any other data needed to execute the machine learning models. In some embodiments, the neural network manager 610 may be associated with dedicated software and/or hardware resources to execute the machine learning models. Although depicted in FIG. 6 as being hosted by a single neural network manager 610, in various embodiments the neural networks may be hosted in multiple neural network managers and/or as part of different components.

As illustrated in FIG. 6 the digital design system 600 also includes training system 612. The training system 612 can teach, guide, tune, and/or train one or more neural networks. In particular, the training system 612 can train a neural network based on a plurality of training data. More specifically, the training system 612 can access, identify, generate, create, and/or determine training input and utilize the training input to train and fine-tune a neural network. In particular, the training system 612 can train, at least, encoder-decoder network 616, encoder-decoder network 618, and encoder 620, based on training data.

As illustrated in FIG. 6, the digital design system 600 also includes the storage manager 614. The storage manager 614 maintains data for the digital design system 600. The storage manager 614 can maintain data of any type, size, or kind as necessary to perform the functions of the digital design system 600. The storage manager 614, as shown in FIG. 6, includes input data 622, training data 624, a frames features memory 626, a matting memory 628, and alpha matte frames memory 630. In particular, the input data 622 may include video sequences and input masked video frames for a single frame of corresponding video sequences received by the digital design system 600. The training data 624 can include a plurality of training video sequences and corresponding training masked video frames and training alpha matte frames utilized by the training system 612 to train one or more neural networks to generate alpha matte video sequence representations of input video sequences.

In one or more embodiments, the frames features memory 626 can include the alpha matte frames generated by the video matting module 608 for previous frames of the video sequence. In one or more embodiments, the features data in the frames features memory 626 is used to guide the masking process performed by the video segmentation module 606. In some embodiments, the frames features memory 626 can also include the masked video frames generated by the video segmentation module 606. In one or more embodiments, the matting memory 628 can include the alpha matte frames generated by the video matting module 608 for previous frames of the video sequence. In one or more embodiments, the features data in the matting memory 628 is used to guide the alpha matting process performed by the video matting module 608.

In one or more embodiments, the alpha matte frames memory 630 can include the alpha matte frames for a video sequence as they are sequentially generated by the digital design system 600. In one or more embodiments, the alpha matte frames for a video sequence can be stored in alpha matte frames memory 630 until all video frames of the video sequence are processed and the alpha matte video sequence representation can be generated.

Each of the components 602-614 of the digital design system 600 and their corresponding elements (as shown in FIG. 6) may be in communication with one another using any suitable communication technologies. It will be recognized that although components 602-614 and their corresponding elements are shown to be separate in FIG. 6, any of components 602-614 and their corresponding elements may be combined into fewer components, such as into a single facility or module, divided into more components, or configured into different components as may serve a particular embodiment.

The components 602-614 and their corresponding elements can comprise software, hardware, or both. For example, the components 602-614 and their corresponding elements can comprise one or more instructions stored on a computer-readable storage medium and executable by processors of one or more computing devices. When executed by the one or more processors, the computer-executable instructions of the digital design system 600 can cause a client device and/or a server device to perform the methods described herein. Alternatively, the components 602-614 and their corresponding elements can comprise hardware, such as a special purpose processing device to perform a certain function or group of functions. Additionally, the components 602-614 and their corresponding elements can comprise a combination of computer-executable instructions and hardware.

Furthermore, the components 602-614 of the digital design system 600 may, for example, be implemented as one or more stand-alone applications, as one or more modules of an application, as one or more plug-ins, as one or more library functions or functions that may be called by other applications, and/or as a cloud-computing model. Thus, the components 602-614 of the digital design system 600 may be implemented as a stand-alone application, such as a desktop or mobile application. Furthermore, the components 602-614 of the digital design system 600 may be implemented as one or more web-based applications hosted on a remote server. Alternatively, or additionally, the components of the digital design system 600 may be implemented in a suite of mobile device applications or “apps.”

As shown, the digital design system 600 can be implemented as a single system. In other embodiments, the digital design system 600 can be implemented in whole, or in part, across multiple systems. For example, one or more functions of the digital design system 600 can be performed by one or more servers, and one or more functions of the digital design system 600 can be performed by one or more client devices. The one or more servers and/or one or more client devices may generate, store, receive, and transmit any type of data used by the digital design system 600, as described herein.

In one implementation, the one or more client devices can include or implement at least a portion of the digital design system 600. In other implementations, the one or more servers can include or implement at least a portion of the digital design system 600. For instance, the digital design system 600 can include an application running on the one or more servers or a portion of the digital design system 600 can be downloaded from the one or more servers. Additionally or alternatively, the digital design system 600 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including the video sequence and input masked video frame stored at the one or more servers. Moreover, the client device can receive a request (i.e., via user input) to generate an alpha matte video sequence representation of the video sequence and provide the request to the one or more servers. Upon receiving the request, the one or more servers can automatically perform the methods and processes described above to generate an alpha matte video sequence representation of the video sequence. The one or more servers can provide the alpha matte video sequence representation of the video sequence to the client device for display to the user.

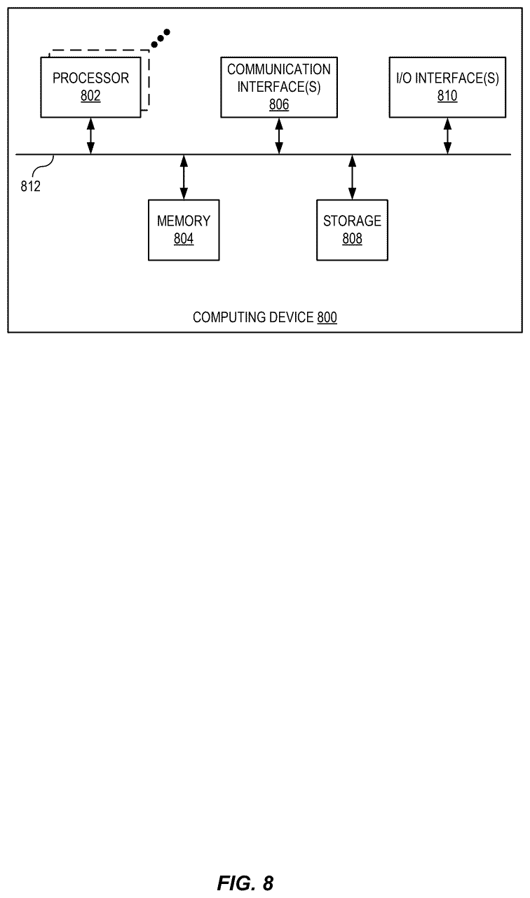

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 8. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 8.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 8.

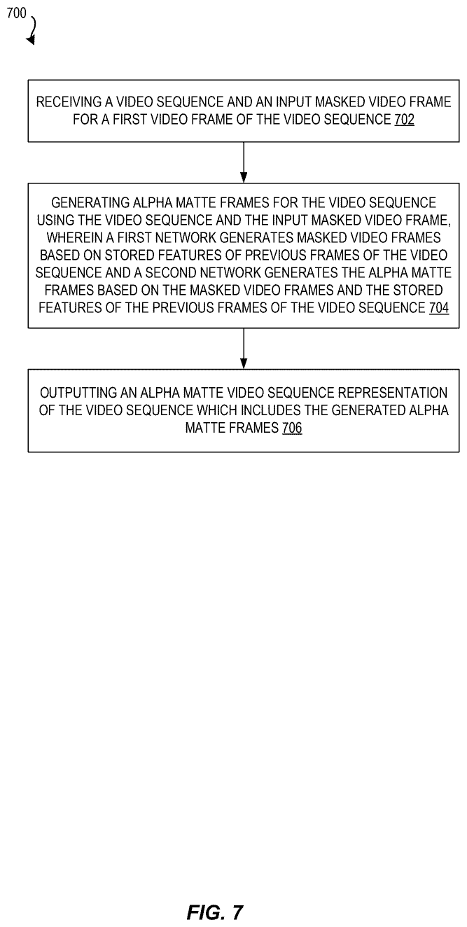

FIGS. 1-6, the corresponding text, and the examples, provide a number of different systems and devices that generate an alpha matte video sequence representation of a video sequence using cyclical guidance. In addition to the foregoing, embodiments can also be described in terms of flowcharts comprising acts and steps in a method for accomplishing a particular result. For example, FIG. 7 illustrates a flowchart of an exemplary method in accordance with one or more embodiments. The method described in relation to FIG. 7 may be performed with fewer or more steps/acts or the steps/acts may be performed in differing orders. Additionally, the steps/acts described herein may be repeated or performed in parallel with one another or in parallel with different instances of the same or similar steps/acts.

FIG. 7 illustrates a flowchart of a series of acts in a method of generating an alpha matte video sequence representation of a video sequence using machine learning models of a digital design system in accordance with one or more embodiments. In one or more embodiments, a method 700 is performed in a digital medium environment that includes the digital design system 600. The method 700 is intended to be illustrative of one or more methods in accordance with the present disclosure and is not intended to limit potential embodiments. Alternative embodiments can include additional, fewer, or different steps than those articulated in FIG. 7.

As illustrated in FIG. 7, the method 700 includes an act 702 of receiving a video sequence and an input masked video frame for a first video frame of the video sequence. In one or more embodiments, the video sequence is an input to the digital design system for which a user is requesting an alpha matte video sequence representation be created. In one or more embodiments, the input masked video frame is a binary mask that designates each pixel of the first video frame of the video sequence as a foreground pixel or a background pixel. In one or more embodiments, the digital design system receives the video sequence and the input masked video frame from a user (e.g., via a computing device). In one or more embodiments, the user may select or provide the video sequence and the input masked video frame in an application, or the user may submit the video sequence and the input masked video frame to a web service or an application configured to receive inputs. The video sequence can be a portion selected from a longer video sequence. For example, after providing the video sequence to the application, the application can provide an interface to enable the user to select a portion of the video sequence.

As illustrated in FIG. 7, the method 700 includes an act 704 of generating alpha matte frames for the video sequence using the video sequence and the input masked video frame, wherein a first network generates masked video frames based on stored features of previous frames of the video sequence and a second network generates the alpha matte frames based on the masked video frames and the stored features of the previous frames of the video sequence. In one or more embodiments, a first encoder-decoder network trained to generate masked video frames receives the first video frame of the video sequence and the input masked video frame for the first video frame of the video sequence. In one or more embodiments, features of the input masked video frame for the first video frame of the video sequence are stored in a frames features memory. In such embodiments, as the first encoder-decoder processes the first video frame, the features of the input masked video frame for the first video frame of the video sequence are combined with the features of the first video frame generated by an encoder of the first encoder-decoder network. The decoder of the first encoder-decoder network then generates a first masked video frame based on the features of the first video frame of the video sequence and the features of the input masked video frame for the first video frame of the video sequence.

In one or more embodiments, the first masked video frame is then sent to a second encoder-decoder network trained to generate alpha mattes. The second encoder-decoder network generates a first alpha matte frame based on the first masked video frame. In one or more embodiments, the second encoder-decoder network generates an initial alpha matte frame by passing the first video frame and the first masked video frame through the second encoder-decoder network. The initial alpha matte frame is then provided to a memory encoder to generate features of the initial alpha matte frame. The features of the initial alpha matte frame and features of the first video frame are then combined and stored in the matting memory. The second encoder-decoder network then generates the first alpha matte frame representing the first video frame of the video sequence by passing the first video frame and the first masked video frame through the second encoder-decoder network, wherein one or more features in the matting memory are combined with features of the first video frame and the first masked video frame in one or more layers of a decoder in the second encoder-decoder network. In one or more embodiments, a frames features memory and the matting memory are updated with at least features of the first alpha matte frame. In one or more embodiments, the frames features memory is further updated with the first masked video frame.

In one or more embodiments, each additional video frame of the video sequence is then sequentially processed through the digital design system to generate corresponding alpha matte frames. For example, using the process described previously, the first encoder-decoder generates a second masked video frame for a second video frame, or next frame, consecutive to the first video frame using the second video frames and the stored features of the first alpha matte frame generated previously. Similarly, the second encoder-decoder network generates a second alpha matte frame representing the second video frame of the video sequence using the second masked video frame for the second video frame of the video sequence and the stored features of the first alpha matte frame generated previously. The frames features memory and the matting memory are then updated with at least features of the second alpha matte frame. This process is performed iteratively until all video frames, or a selected subset of all video frames, of the video sequence have been processed.

As illustrated in FIG. 7, the method 700 includes an act 706 of outputting an alpha matte video sequence representation of the video sequence which includes the generated alpha matte frames. After processing all the video frames, of the selected subset of the video frames, of the video sequence, the alpha matte frames can be combined to generate the alpha matte video sequence representation of the video sequence.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 that may be configured to perform one or more of the processes described above. One will appreciate that one or more computing devices such as the computing device 800 may implement the digital design system. As shown by FIG. 8, the computing device can comprise a processor 802, memory 804, one or more communication interfaces 806, a storage device 808, and one or more I/O devices/interfaces 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 808 and decode and execute them. In various embodiments, the processor(s) 802 may include one or more central processing units (CPUs), graphics processing units (GPUs), field programmable gate arrays (FPGAs), systems on chip (SoC), or other processor(s) or combinations of processors.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 may be internal or distributed memory.

The computing device 800 can further include one or more communication interfaces 806. A communication interface 806 can include hardware, software, or both. The communication interface 806 can provide one or more interfaces for communication (such as, for example, packet-based communication) between the computing device and one or more other computing devices 800 or one or more networks. As an example and not by way of limitation, communication interface 806 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can comprise hardware, software, or both that couples components of computing device 800 to each other.

The computing device 800 includes a storage device 808 includes storage for storing data or instructions. As an example, and not by way of limitation, storage device 808 can comprise a non-transitory storage medium described above. The storage device 808 may include a hard disk drive (HDD), flash memory, a Universal Serial Bus (USB) drive or a combination these or other storage devices. The computing device 800 also includes one or more input or output (“I/O”) devices/interfaces 810, which are provided to allow a user to provide input to (such as user strokes), receive output from, and otherwise transfer data to and from the computing device 800. These I/O devices/interfaces 810 may include a mouse, keypad or a keyboard, a touch screen, camera, optical scanner, network interface, modem, other known I/O devices or a combination of such I/O devices/interfaces 810. The touch screen may be activated with a stylus or a finger.

The I/O devices/interfaces 810 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 810 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a video sequence and an input masked video frame for a first video frame of the video sequence;
generating alpha matte frames for the video sequence using the video sequence and the input masked video frame, wherein a first network generates masked video frames based on stored features of previous frames of the video sequence and a second network generates the alpha matte frames based on the masked video frames and the stored features of the previous frames of the video sequence; and
outputting an alpha matte video sequence representation of the video sequence which includes the generated alpha matte frames.

2. The method of claim 1, wherein generating the alpha matte frames for the video sequence using the video sequence and the input masked video frame further comprises:
receiving, by the first network, the first video frame of the video sequence and the input masked video frame for the first video frame of the video sequence;
generating, by the first network, a first masked video frame based on the first video frame of the video sequence and the input masked video frame for the first video frame of the video sequence;
generating, by the second network, a first alpha matte frame based on the first masked video frame; and
updating a frames features memory and a matting memory with at least features of the first alpha matte frame.

3. The method of claim 2, wherein updating the frames features memory and the matting memory with at least the features of the first alpha matte frame further comprises:
passing the first video frame of the video sequence and the first alpha matte frame through an encoder to generate the features of the first alpha matte frame; and
storing the features of the first alpha matte frame in the matting memory.

4. The method of claim 2, further comprising:
updating the frames features memory with second features representing the first masked video frame.

5. The method of claim 2, further comprising:
consecutively processing each additional video frame of the video sequence by the first network and the second network to generate corresponding alpha matte frames.

6. The method of claim 5, wherein consecutively processing each additional video frame comprises:
generating, by the first network, a next masked video frame for a next video frame of the video sequence using the stored features of the previous frames of the video sequence, wherein the next video frame is consecutive to a previous video frame, and wherein the stored features of the previous frames of the video sequence includes at least the first alpha matte frame representing the first video frame of the video sequence;
generating, by the second network, a next alpha matte frame representing the next video frame of the video sequence using the next masked video frame for the next video frame of the video sequence and the stored features of the previous frames of the video sequence; and
updating the frames features memory and the matting memory with at least features of the next alpha matte frame.

7. The method of claim 2, wherein generating the first alpha matte frame based on the input masked video frame further comprises:
generating an initial alpha matte frame by passing the first video frame and the first masked video frame through the second network; and
generating the first alpha matte frame representing the first video frame of the video sequence by passing the first video frame and the first masked video frame through the second network, wherein one or more features of the matting memory are combined with features of the first video frame and the first masked video frame in one or more layers of a decoder in the second network.

8. The method of claim 1, wherein the input masked video frame designates each pixel of the first video frame of the video sequence as a foreground pixel or a background pixel.

9. A non-transitory computer-readable medium storing executable instructions, which when executed by a processing device, cause the processing device to perform operations comprising:
receiving a video sequence and an input masked video frame for a first video frame of the video sequence;
generating alpha matte frames for the video sequence using the video sequence and the input masked video frame, wherein a first network generates masked video frames based on stored features of previous frames of the video sequence and a second network generates the alpha matte frames based on the masked video frames and the stored features of the previous frames of the video sequence; and
outputting an alpha matte video sequence representation of the video sequence which includes the generated alpha matte frames.

10. The non-transitory computer-readable medium of claim 9, wherein the instructions to generate the alpha matte frames for the video sequence using the video sequence and the input masked video frame further comprise:
receiving, by the first network, the first video frame of the video sequence and the input masked video frame for the first video frame of the video sequence;
generating, by the first network, a first masked video frame based on the first video frame of the video sequence and the input masked video frame for the first video frame of the video sequence;
generating, by the second network, a first alpha matte frame based on the first masked video frame; and
updating a frames features memory and a matting memory with at least features of the first alpha matte frame.

11. The non-transitory computer-readable medium of claim 10, wherein the instructions further comprise:
updating the frames features memory with second features representing the first masked video frame.

12. The non-transitory computer-readable medium of claim 10, wherein the instructions further comprise:
consecutively processing each additional video frame of the video sequence by the first network and the second network to generate corresponding alpha matte frames.

13. The non-transitory computer-readable medium of claim 12, wherein the instructions to consecutively process each additional video frame further comprise:
generating, by the first network, a next masked video frame for a next video frame of the video sequence using the stored features of the previous frames of the video sequence, wherein the next video frame is consecutive to a previous video frame, and wherein the stored features of the previous frames of the video sequence includes at least the first alpha matte frame representing the first video frame of the video sequence;
generating, by the second network, a next alpha matte frame representing the next video frame of the video sequence using the next masked video frame for the next video frame of the video sequence and the stored features of the previous frames of the video sequence; and
updating the frames features memory and the matting memory with at least features of the next alpha matte frame.

14. The non-transitory computer-readable medium of claim 10, wherein the instructions to generate the first alpha matte frame based on the input masked video frame further comprises:
generating an initial alpha matte frame by passing the first video frame and the first masked video frame through the second network; and
generating the first alpha matte frame representing the first video frame of the video sequence by passing the first video frame and the first masked video frame through the second network, wherein one or more features of the matting memory are combined with features of the first video frame and the first masked video frame in one or more layers of a decoder in the second network.

15. A system comprising:
a memory component; and
a processing device coupled to the memory component, the processing device to perform operations comprising:
receiving a video sequence and an input masked video frame for a first video frame of the video sequence;
generating alpha matte frames for the video sequence using the video sequence and the input masked video frame, wherein a first network generates masked video frames based on stored features of previous frames of the video sequence and a second network generates the alpha matte frames based on the masked video frames and the stored features of the previous frames of the video sequence; and
outputting an alpha matte video sequence representation of the video sequence which includes the generated alpha matte frames.

16. The system of claim 15, wherein the operations of generating the alpha matte frames for the video sequence using the video sequence and the input masked video frame further comprise:
receiving, by the first network, the first video frame of the video sequence and the input masked video frame for the first video frame of the video sequence;
generating, by the first network, a first masked video frame based on the first video frame of the video sequence and the input masked video frame for the first video frame of the video sequence;
generating, by the second network, a first alpha matte frame based on the first masked video frame; and
updating a frames features memory and a matting memory with at least features of the first alpha matte frame.

17. The system of claim 16, wherein the operations further comprise:
updating the frames features memory with second features representing the first masked video frame.

18. The system of claim 16, wherein the operations further comprise:
consecutively processing each additional video frame of the video sequence by the first network and the second network to generate corresponding alpha matte frames.

19. The system of claim 18, wherein the operations of consecutively processing each additional video frame further comprise:
generating, by the first network, a next masked video frame for a next video frame of the video sequence using the stored features of the previous frames of the video sequence, wherein the next video frame is consecutive to a previous video frame, and wherein the stored features of the previous frames of the video sequence includes at least the first alpha matte frame representing the first video frame of the video sequence;
generating, by the second network, a next alpha matte frame representing the next video frame of the video sequence using the next masked video frame for the next video frame of the video sequence and the stored features of the previous frames of the video sequence; and
updating the frames features memory and the matting memory with at least features of the next alpha matte frame.

20. The system of claim 16, wherein the operations of generating the first alpha matte frame based on the input masked video frame further comprise:
generating an initial alpha matte frame by passing the first video frame and the first masked video frame through the second network; and
generating the first alpha matte frame representing the first video frame of the video sequence by passing the first video frame and the first masked video frame through the second network, wherein one or more features of the matting memory are combined with features of the first video frame and the first masked video frame in one or more layers of a decoder in the second network.
